(19) United States
(12) Patent Application Publication
(10) Pub. No.: US 2026/0080836 A1
(43) Pub. Date: Mar. 19, 2026

(54) DRIVING CIRCUIT AND ELECTRONIC DEVICE HAVING THE SAME

(71) Applicant: Samsung Display Co., Ltd., Yongin-si (KR)

(72) Inventors: CHAEHEE PARK, Yongin-si (KR); JONGMAN BAE, Yongin-si (KR); WOO-CHUL KIM, Yongin-si (KR); JINYOUNG JEON, Yongin-si (KR)

(21) Appl. No.: 19/246,230

(22) Filed: Jun. 23, 2025

(30) Foreign Application Priority Data
Sep. 13, 2024 (KR) 10-2024-0125923

(51) Int. Cl. G09G 3/3275; G09G 3/32; G09G 3/3233; G09G 3/3258

(52) U.S. Cl. CPC G09G 3/3275; G09G 3/32; G09G 3/3233; G09G 3/3258; G09G 2300/0842; G09G 2310/027; G09G 2310/08; G09G 2320/10; G09G 2330/021; G09G 2340/0435; G09G 2380/02

(57) ABSTRACT

An electronic device includes a display panel, a processor which outputs a transmission signal, and a driving controller which receives the transmission signal and outputs an image data signal based on the transmission signal in a way such that an image is displayed on the display panel. The driving controller includes a memory that stores the image data signal. The processor outputs the transmission signal when a current image corresponding to a part of the display panel is different from a previous image corresponding to the part of the display panel in a still-image mode. The driving controller allows the display panel to be refreshed by the image data signal read from the memory when a display time of a still image corresponding to the part of the display panel reaches a predetermined time in the still-image mode.

This application claims priority to Korean Patent Application No. 10-2024-0125923, filed on Sep. 13, 2024, and all the benefits accruing therefrom under 35 U.S.C. § 119, the content of which in its entirety is herein incorporated by reference.

### BACKGROUND

### (1) Field

Embodiments of the present disclosure described herein relate to a driving circuit and an electronic device including the driving circuit.

### (2) Description of the Related Art

An electronic device may include pixels connected to data lines and scan lines. Each of the pixels includes a light emitting element and a pixel circuit for controlling the light emitting element. The pixel circuit may provide a current corresponding to a data signal to the light emitting element. In this case, light having predetermined luminance may be generated in response to a current flowing through the light emitting element.

In an electronic device including pixels to display an image, the display quality of the image displayed thereon may be improved by increasing the operating frequency of the electronic device, while the power consumption thereof may be reduced by lowering the operating frequency of the electronic device.

### SUMMARY

Embodiments of the present disclosure provide an electronic device capable of operating at various driving frequencies.

According to an embodiment, an electronic device includes a display panel, a processor which outputs a transmission signal, and a driving controller which receives the transmission signal and outputs an image data signal based on the transmission signal in a way such that an image is displayed on the display panel. In such an embodiment, the driving controller includes a memory which stores the image data signal. In such an embodiment, the processor outputs the transmission signal when a current image corresponding to a part of the display panel is different from a previous image corresponding to the part of the display panel in a still-image mode. In such an embodiment, the driving controller allows the display panel to be refreshed by the image data signal read from the memory when a display time of a still image corresponding to the part of the display panel reaches a predetermined time in the still-image mode.

In an embodiment, when the current image corresponding to the part of the display panel is different from the previous image corresponding to the part of the display panel, the processor may output the transmission signal corresponding to the part of the display panel. In such an embodiment, the driving controller may store the image data signal corresponding to the part of the display panel in the memory

In an embodiment, during a refresh frame of the still-image mode, the driving controller may read out the image data signal corresponding to a full image of the display panel from the memory and may output the image data signal corresponding to the full image to the display panel.

In an embodiment, the driving controller may set a next frame as the refresh frame after the transmission signal corresponding to a new image is received in the still-image mode.

In an embodiment, when the still-image mode starts, the processor may output the transmission signal corresponding to a full image of the display panel.

In an embodiment, when the full image of a current frame is identical to the full image of a previous frame in the still-image mode, the processor may not output the transmission signal to the driving controller.

In an embodiment, the transmission signal may include a still-image mode signal indicating the still-image mode. In such an embodiment, the driving controller may restore the still-image mode signal included in the still image signal.

In an embodiment, the driving controller may further include a receiver which restores an image signal, a multi-frequency mode signal, and the still-image mode signal based on the transmission signal, where the image signal, the multi-frequency mode signal, and the still-image mode signal are included in the transmission signal, and a controller which converts the image signal into the image data signal. In such an embodiment, when the display time of the still image reaches the predetermined time while the still-image mode signal is at an active level, the controller may output the image data signal read from the memory.

In an embodiment, when the multi-frequency mode signal is at the active level, the controller may output the image data signal corresponding to the transmission signal.

In an embodiment, when the multi-frequency mode signal is at the active level and the still-image mode signal is at an inactive level, the memory may be maintained in an off state.

In an embodiment, when the display time of the still image corresponding to the part of the display panel reaches the predetermined time in a multi-frequency mode, the processor may output the transmission signal corresponding to a full image of the display panel to the driving controller and the controller may allow the display panel to be refreshed.

In an embodiment, during a first frame where the still-image mode starts, the processor may output the transmission signal corresponding to a full image of the display panel to the driving controller. In such an embodiment, in the first frame where the still-image mode starts, the driving controller may store the image data signal corresponding to the transmission signal in the memory.

According to an embodiment, an electronic device includes a display panel, a processor which outputs a transmission signal, and a driving controller that receives the transmission signal and outputs an image data signal based on the transmission signal in a way such that an image is displayed on the display panel. In such an embodiment, the driving controller includes a memory which stores the image data signal. In such an embodiment, the processor divides the display panel into a first display area and a second display area in a still-image mode and outputs the transmission signal when a current image corresponding to the second display area is different from a previous image corresponding to the second display area. In such an embodiment, the driving controller allows the display panel to be refreshed by the image data signal read from the memory when a display time of a still image corresponding to the first display area reaches a predetermined time in the still-image mode.

In an embodiment, when the current image corresponding to the second display area of the display panel is different from the previous image corresponding to the second display area of the display panel, the processor may output the transmission signal corresponding to the second display area of the display panel. In such an embodiment, the driving controller may store the image data signal corresponding to the second display area of the display panel in the memory.

In an embodiment, during a refresh frame of the still-image mode, the driving controller may read out the image data signal corresponding to a full image of the display panel from the memory.

In an embodiment, when the full image of a current frame is identical to the full image of a previous frame in the still-image mode, the processor may not output the transmission signal.

According to an embodiment, a driving circuit includes a driving controller which receives a transmission signal from an outside and outputs an image data signal based on the transmission signal and a data driving circuit which converts the image data signal into a data signal. In such an embodiment, the driving controller includes a memory which stores the image data signal. In such an embodiment, the driving controller outputs the image data signal read from the memory to the data driving circuit when a display time of a still image reaches a predetermined time in a still-image mode.

In an embodiment, during a refresh frame of the still-image mode, the driving controller may read out the image data signal corresponding to a full image of a display panel from the memory and may output the image data signal corresponding the full image of the display panel to the data driving circuit.

In an embodiment, the driving controller may further include a receiver which restores an image signal, a multi-frequency mode signal, and a still-image mode signal, where the image signal, the multi-frequency mode signal, and the still-image mode signal are included in the transmission signal, and a controller which converts the image signal into the image data signal. In such an embodiment, when the display time of the still image reaches the predetermined time while the still-image mode signal is at an active level, the controller may output the image data signal read from the memory.

In an embodiment, when the multi-frequency mode signal is at the active level and the still-image mode signal is at an inactive level, the memory may be maintained in an off state.

### BRIEF DESCRIPTION OF THE DRAWINGS

The above and other features of embodiments of the present disclosure will become apparent by describing in detail embodiments thereof with reference to the accompanying drawings.

FIG. 1 shows an electronic device, according to an embodiment of the present disclosure.

FIG. 2 shows an image displayed on an electronic device, according to an embodiment of the present disclosure.

FIGS. 3A and 3B are perspective views of an electronic device, according to an embodiment of the present disclosure.

FIG. 4A is a diagram for describing an operation of an electronic device in a normal mode.

FIG. 4B is a drawing for describing an operation of an electronic device in a still-image mode.

FIG. 4C is a diagram for describing an operation of an electronic device in a multi-frequency mode.

FIG. 5 is a block diagram of an electronic device, according to an embodiment of the present disclosure.

FIG. 6 is a circuit diagram of a pixel, according to an embodiment of the present disclosure.

FIG. 7 is a block diagram showing a configuration of a processor and a driving controller of an electronic device.

FIG. 8A is a drawing showing an image displayed on a display panel in a normal mode.

FIG. 8B is a drawing showing an image displayed on a display panel in a multi-frequency mode.

FIGS. 9 and 10 are drawings for describing operations of a processor and a driving controller in a normal mode and a multi-frequency mode.

FIGS. 11A, 11B, 11C, 11D, and 11E are drawings showing images displayed on a display panel in a still-image mode.

FIGS. 12 and 13 are drawings for describing operations of a processor and a driving controller in a still-image mode.

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. It will be understood that when an element is referred to as being “on” another element, it can be directly on the other element or intervening elements may be present therebetween. In contrast, when an element is referred to as being “directly on” another element, there are no intervening elements present.

In the specification, the expression that a first component (or region, layer, part, etc.) is “connected with”, or “coupled with” a second component means that the first component is directly connected with, or directly coupled with the second component or means that a third component is interposed therebetween.

The same sign refers to the same element. Also, in drawings, the thickness, ratio, and dimension of components are exaggerated for effectiveness of description of technical contents.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The terms “below” or “beneath” can, therefore, encompass both an orientation of above and below.

The terminology used herein is for the purpose of describing particular embodiments only and is not intended to be limiting. As used herein, “a”, “an,” “the,” and “at least one” do not denote a limitation of quantity, and are intended to include both the singular and plural, unless the context clearly indicates otherwise. Thus, reference to “an” element in a claim followed by reference to “the” element is inclusive of one element and a plurality of the elements. For example, “an element” has the same meaning as “at least one element,” unless the context clearly indicates otherwise.

“At least one” is not to be construed as limiting “a” or “an.” “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical terms and scientific terms) used in this specification have the same meaning as commonly understood by those skilled in the art to which the present disclosure belongs. Furthermore, terms such as terms defined in the dictionaries commonly used should be interpreted as having a meaning consistent with the meaning in the context of the related technology, and should not be interpreted in ideal or overly formal meanings unless explicitly so defined herein.

Embodiments are described herein with reference to schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

Hereinafter, embodiments of the present disclosure will be described in detail with reference to the accompanying drawings.

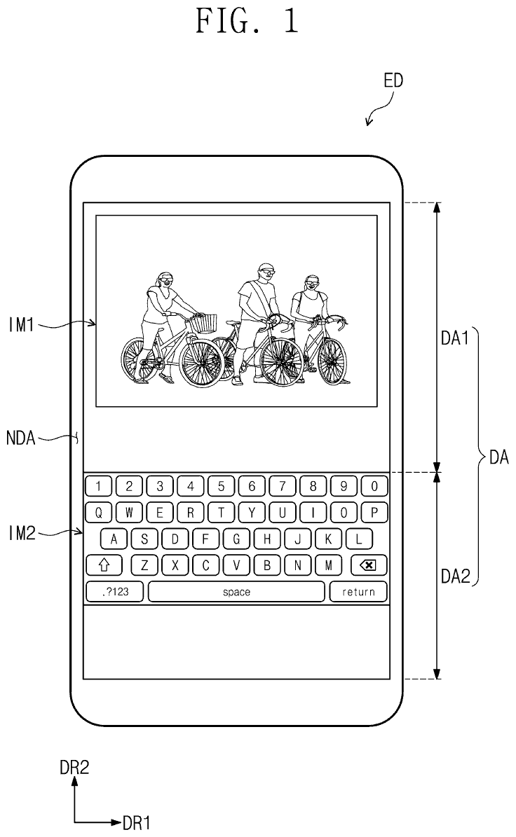

FIG. 1 shows an electronic device ED, according to an embodiment of the present disclosure.

Referring to FIG. 1, in an embodiment, the electronic device ED may be a portable terminal, for example. The portable terminal may include a tablet computer, a smartphone, a personal digital assistant (PDA), a portable multimedia player (PMP), a game console, a wristwatch-type electronic device, and the like. However, the present disclosure is not limited thereto. Embodiments of the present disclosure may be small and medium electronic devices such as a personal computer, a notebook computer, a kiosk, a car navigation unit, and a camera, in addition to large-sized electronic equipment such as a television or an outside billboard. The above examples are provided only as an embodiment, and it is obvious that the present disclosure may be applied to any other electronic device(s) without departing from the concept of the present disclosure.

In an embodiment, as shown in FIG. 1, a display surface of the electronic device ED, on which a first image IM1 and a second image IM2 are displayed, is parallel to a plane defined by a first direction DR1 and a second direction DR2. The electronic device ED includes a plurality of areas separated or divided on the display surface. The display surface includes a display area DA, in which the first image IM1 and the second image IM2 are displayed, and a non-display area NDA adjacent to the display area DA. The non-display area NDA may be referred to as a bezel area. In an embodiment, for example, the display area DA may have a rectangular shape in a plan view. The non-display area NDA surrounds the display area DA. Also, although not illustrated, for example, the electronic device ED may include a shape that is partially curved.

The display area DA of the electronic device ED includes a first display area DA1 and a second display area DA2. In a specific application program, the first image IM1 may be displayed on the first display area DA1, and the second image IM2 may be displayed on the second display area DA2. In an embodiment, for example, the first image IM1 may be an image having a fast change cycle (e.g., video), and the second image IM2 may be an image having a long change period (e.g., a still image such as a photo or text information).

The operating mode of the electronic device ED may include a single frequency mode and a multi-frequency mode. The electronic device ED may drive both the first display area DA1 and the second display area DA2 at a default frequency in the single frequency mode. In the multi-frequency mode, the electronic device ED according to an embodiment may drive the first display area DA1 where the first image IM1 is displayed at a first operating frequency, and may drive the second display area DA2 where the second image IM2 is displayed, at a second operating frequency. In an embodiment, the first operating frequency may be higher than or equal to the default frequency. In an embodiment, the second operating frequency may be lower than the first operating frequency. The electronic device ED may reduce power consumption by lowering the operating frequency of the second display area DA2.

The size of each of the first display area DA1 and the second display area DA2 may be a preset size, and may be changed by an application program.

In an embodiment, when the still image is displayed in the first display area DA1 and the video is displayed in the second display area DA2, the first display area DA1 may be driven at a frequency lower than the default frequency, and the second display area DA2 may be driven at a frequency higher than or equal to the default frequency.

In an embodiment, the display area DA may be divided into three or more display areas. An operating frequency of each of the display areas may be determined depending on the type (a still image or video) of an image displayed in each of the display areas.

In an embodiment, the single frequency mode may include a normal mode and a still-image mode. In the normal mode, the electronic device ED may drive both the first display area DA1 and the second display area DA2 at the default frequency. In the still-image mode, the electronic device ED may drive both the first display area DA1 and the second display area DA2 in a still image frequency lower than the default frequency.

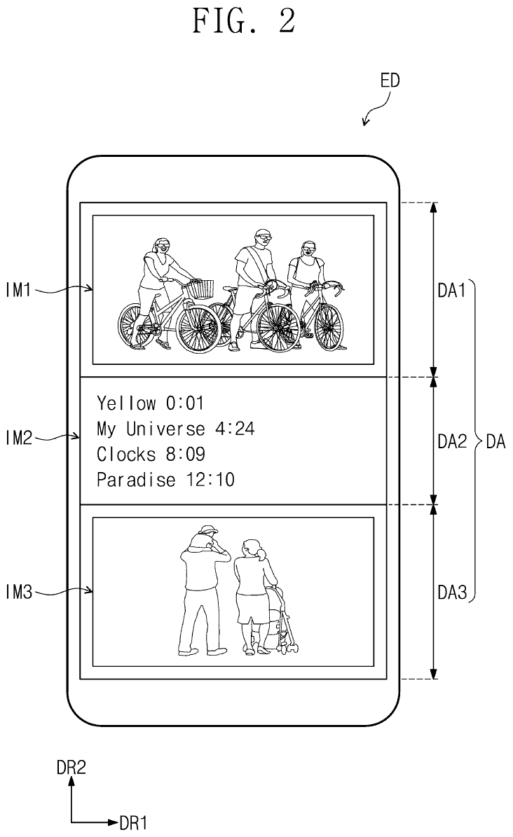

FIG. 2 shows an image displayed on the electronic device ED, according to an embodiment of the present disclosure.

Referring to FIG. 2, in an embodiment, the display area DA of the electronic device ED includes a first display area DA1, a second display area DA2, and a third display area DA3.

In a single frequency mode, the electronic device ED may drive all of the first display area DA1, the second display area DA2, and the third display area DA3 at a default frequency.

In a specific application program, the first image IM1 may be displayed on the first display area DA1, the second image IM2 may be displayed on the second display area DA2, and a third image IM3 may be displayed on the third display area DA3. In an embodiment, the first image IM1 and the third image IM3 may be an image having a fast change cycle (e.g., a video), and the second image IM2 may be an image having a long change period (e.g., a still image such as a photo or text information). In the case, an embodiment of the electronic device ED may operate in a multi-frequency mode.

In the multi-frequency mode, the electronic device ED according to an embodiment may drive the first display area DA1, where the first image IM1 is displayed, and the third display area DA3, where the third image IM3 is displayed, at a first operating frequency and may drive the second display area DA2, where the second image IM2 is displayed, at a second operating frequency. In an embodiment, the first operating frequency may be higher than or equal to the default frequency. In an embodiment, the second operating frequency may be lower than the first operating frequency. The electronic device ED may reduce power consumption by lowering the operating frequency of the second display area DA2.

The size of each of the first display area DA1, the second display area DA2, and the third display area DA3 may be a preset size, and may be changed by an application program.

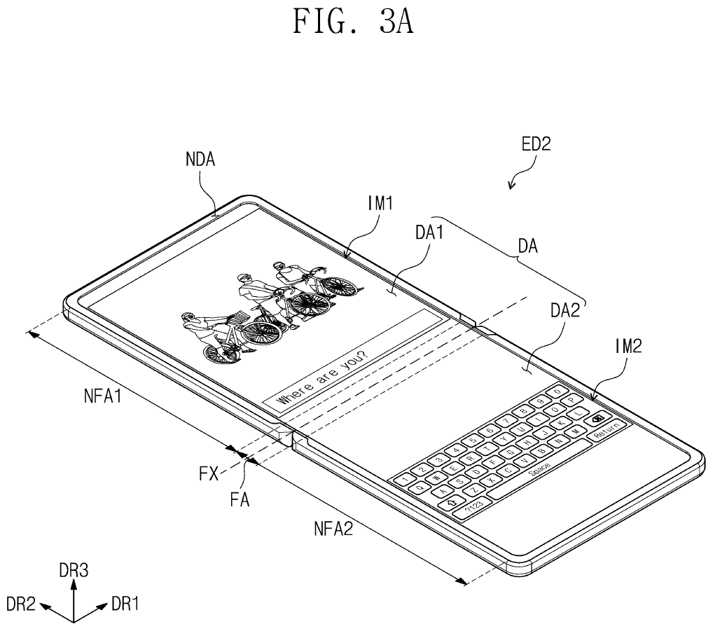

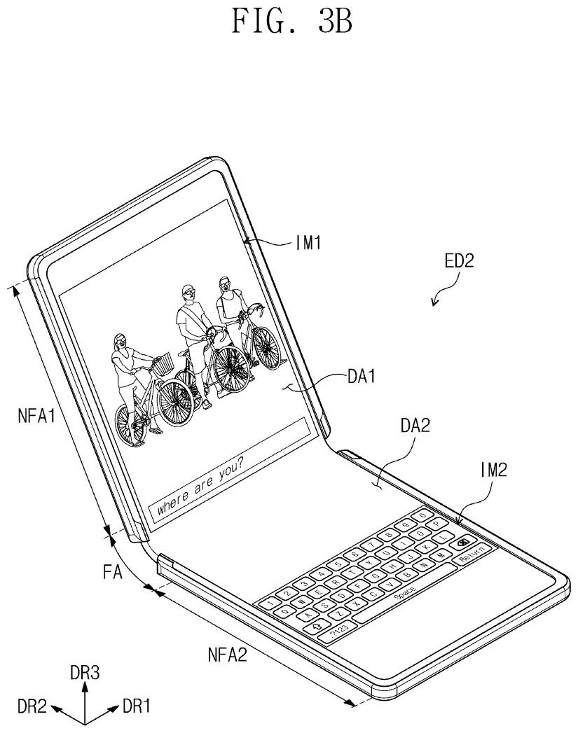

FIGS. 3A and 3B are perspective views of an electronic device ED2, according to an embodiment of the present disclosure. FIG. 3A illustrates the electronic device ED2 in an unfolded state. FIG. 3B illustrates the electronic device ED2 in a folded state.

As shown in FIGS. 3A and 3B, an embodiment of the electronic device ED2 includes the display area DA and the non-display area NDA. The electronic device ED2 may display an image through the display area DA. The display area DA may include a plane defined by the first direction DR1 and the second direction DR2, in a state where the electronic device ED2 is unfolded. A thickness direction of the electronic device ED2 may be parallel to a third direction DR3 intersecting the first direction DR1 and the second direction DR2. Accordingly, front surfaces (or upper surfaces) and back surfaces (or lower surfaces) of members constituting the electronic device ED2 may be defined based on the third direction DR3. The non-display area NDA may be referred to as a bezel area. In an embodiment, for example, the display area DA may have a rectangular shape in a plan view or when viewed in the third direction DR3. The non-display area NDA surrounds the display area DA.

The display area DA may include a first non-folding area NFA1, a folding area FA, and a second non-folding area NFA2. The folding area FA may be bent about a folding axis FX extending in the first direction DR1.

When the electronic device ED2 is folded, the first non-folding area NFA1 and the second non-folding area NFA2 may face each other. Accordingly, while being fully folded, the display area DA may not be exposed to the outside, which may be referred to as “in-folding”. However, embodiments are not limited thereto and the operation of the electronic device ED2 is not limited thereto.

In an embodiment of the present disclosure, when the electronic device ED2 is folded, the first non-folding area NFA1 and the second non-folding area NFA2 may be opposite to each other. Accordingly, while being folded, the first non-folding area NFA1 may be exposed to the outside, which may be referred to as “out-folding”.

The electronic device ED2 may perform only one operation selected from an in-folding operation and an out-folding operation. Alternatively, the electronic device ED2 may perform both the in-folding operation and the out-folding operation. In this case, the same area of the electronic device ED2, for example, the folding area FA may be folded inwardly and outwardly. Alternatively, some areas of the electronic device ED2 may be folded inwardly, and other areas may be folded outwardly.

One folding area and two non-folding areas are illustrated in FIGS. 3A and 3B, but the number of folding areas and the number of non-folding areas are not limited thereto. In an embodiment, for example, the electronic device ED2 may include a plurality of non-folding areas, of which the number is greater than two, and a plurality of folding areas, each of which is interposed between non-folding areas adjacent to one another.

FIGS. 3A and 3B illustrates an embodiment where the folding axis FX is parallel to the minor axis of the electronic device ED2. However, the present disclosure is not limited thereto. In another embodiment, for example, the folding axis FX may extend in a direction parallel to the major axis of the electronic device ED2, for example, the second direction DR2.

FIGS. 3A and 3B illustrate an embodiment where the first non-folding area NFA1, the folding area FA, and the second non-folding area NFA2 are sequentially arranged in the second direction DR2. However, the present disclosure is not limited thereto. In another embodiment, for example, the first non-folding area NFA1, the folding area FA, and the second non-folding area NFA2 may be sequentially arranged in the first direction DR1.

The plurality of display areas DA1 and DA2 may be defined in the display area DA of the electronic device ED2. FIG. 3A illustrates an embodiment where only two display areas DA1 and DA2 are defined in the display area DA as an example. However, the number of display areas DA1 and DA2 is not limited thereto.

The plurality of display areas DA1 and DA2 may include the first display area DA1 and the second display area DA2. In an embodiment, for example, the first display area DA1 may be an area where the first image IM1 is displayed, and the second display area DA2 may be an area in which the second image IM2 is displayed. In an embodiment, for example, the first image IM1 may be a video, and the second image IM2 may be a still image.

The electronic device ED2 according to an embodiment may operate differently depending on an operating mode. The operating mode of the electronic device ED2 may include a single frequency mode and a multi-frequency mode. The single frequency mode of the electronic device ED2 may include a normal mode and a still-image mode.

In the normal mode, the electronic device ED2 may drive both the first display area DA1 and the second display area DA2 at the default frequency. In the still-image mode, the electronic device ED2 may drive both the first display area DA1 and the second display area DA2 in a still image frequency lower than the default frequency. In the multi-frequency mode, the electronic device ED2 according to an embodiment may drive the first display area DA1 where the first image IM1 is displayed at a first operating frequency, and may drive the second display area DA2 where the second image IM2 is displayed, at a second operating frequency. In an embodiment, the first operating frequency may be higher than or equal to the default frequency. The second operating frequency may be lower than the first operating frequency.

The size of each of the first display area DA1 and the second display area DA2 may be a preset size, and may be changed by an application program. In an embodiment, the first display area DA1 may correspond to the first non-folding area NFA1, and the second display area DA2 may correspond to the second non-folding area NFA2. In addition, a first portion of the folding area FA may correspond to the first display area DA1, and a second portion of the folding area FA may correspond to the second display area DA2.

In an embodiment, the entire folding area FA may correspond to only one of the first display area DA1 and the second display area DA2.

In an embodiment, the first display area DA1 may correspond to the first portion of the first non-folding area NFA1, and the second display area DA2 may correspond to the second portion of the first non-folding area NFA1, the folding area FA, and the second non-folding area NFA2. That is, the size of the second display area DA2 may be greater than the size of the first display area DA1.

In an embodiment, the first display area DA1 may correspond to the first non-folding area NFA1, the folding area FA, and the first portion of the second non-folding area NFA2, and the second display area DA2 may be the second portion of the second non-folding area NFA2. That is, the size of the first display area DA1 may be greater than the size of the second display area DA2.

As illustrated in FIG. 3B, in a state where the folding area FA is folded, the first display area DA1 may correspond to the first non-folding area NFA1, and the second display area DA2 may correspond to the folding area FA and the second non-folding area NFA2.

FIGS. 3A and 3B illustrates an embodiment where the electronic device ED2 includes only one folding area, as an example of an electronic device. However, the present disclosure is not limited thereto. In another embodiment, for example, the present disclosure may also be applied to an electronic device having two or more folding areas, a rollable electronic device, or a slidable electronic device.

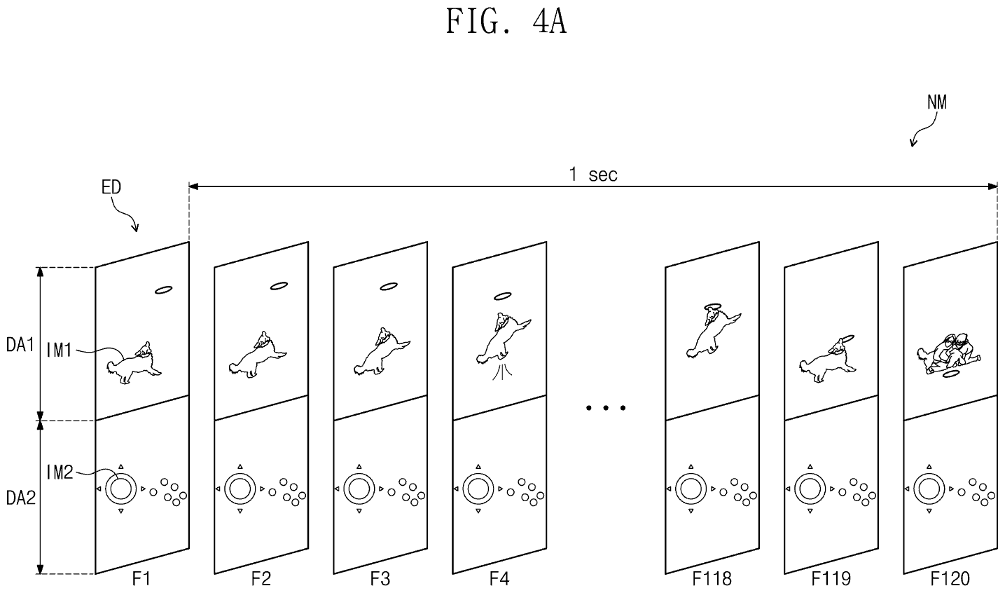

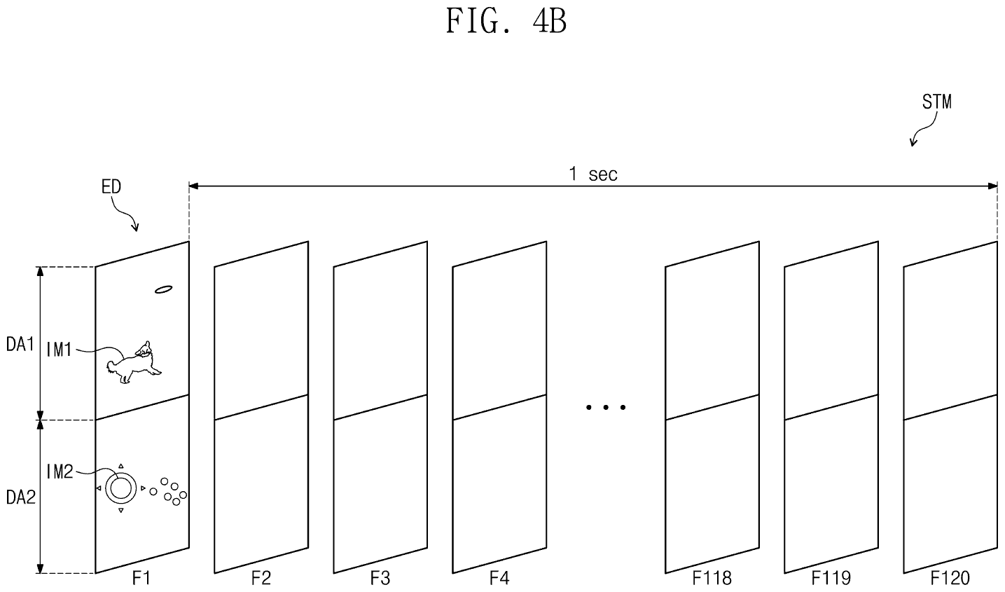

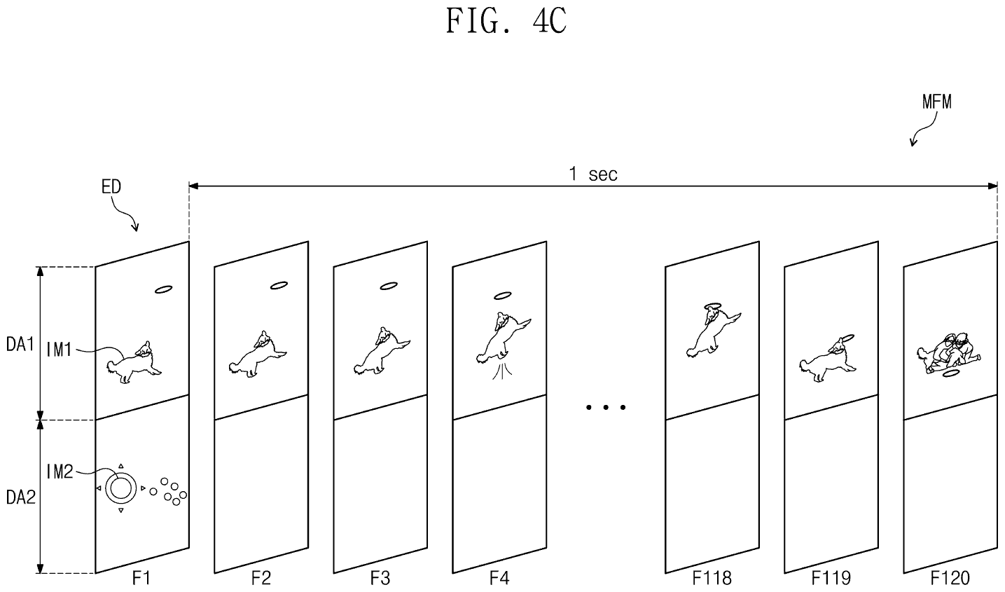

FIG. 4A is a diagram for describing an operation of the electronic device ED in a normal mode.

FIG. 4B is a drawing for describing an operation of the electronic device ED in a still-image mode.

FIG. 4C is a diagram for describing an operation of the electronic device ED in a multi-frequency mode.

Referring to FIG. 4A, the first image IM1 displayed in the first display area DA1 may be a video. The second image IM2 displayed in the second display area DA2 may be a still image or an image (having a long change period (e.g., a keypad image for manipulating a game). The first image IM1 displayed in the first display area DA1 and the second image IM2 displayed in the second display area DA2 are shown in FIG. 4A are examples, and various images may be displayed on the electronic device ED.

In a normal mode NM, the operating frequency of the first display area DA1 and the second display area DA2 of the electronic device ED is a default frequency. In an embodiment, for example, the default frequency may be 120 hertz (Hz). In the normal mode NM, images of first to 120th frames F1 to F120 may be sequentially displayed in the first display area DA1 and the second display area DA2 of the electronic device ED for one second.

Referring to FIG. 4B, in a still-image mode STM, the first image IM1 displayed in the first display area DA1 and the second image IM2 displayed in the second display area DA2 may be still images.

In the still-image mode STM, the operating frequency of the first display area DA1 and the second display area DA2 of the electronic device ED may be a still image frequency lower than the default frequency. In an embodiment, for example, when the default frequency is 120 Hz, the still image frequency may be 1 Hz. In this case, a data signal corresponding to the first image IM1 and the second image IM2 may be provided to the first display area DA1 and the second display area DA2 during only the first frame F1. That is, because a new data signal is not provided to the first display area DA1 and the second display area DA2 during the second to 120th frames F2 to F120, the second image IM1 and the second image IM2, which are the same as the second image IM1 and the second image IM2 during the first frame F1, may be displayed on the electronic device ED during the second to 120th frames F2 to F120.

Referring to FIG. 4C, in a multi-frequency mode MFM, the electronic device ED may set an operating frequency of the first display area DA1, in which the first image IM1 (i.e., a video) is displayed, as the first operating frequency, and may set an operating frequency of the second display area DA2, in which the second image IM2 (i.e., a still image) is displayed, as a second operating frequency lower than the first operating frequency. The first operating frequency may be 120 Hz, and the second operating frequency may be 1 Hz. The first operating frequency and the second operating frequency may be variously changed.

In the multi-frequency mode MFM, when the first operating frequency is 120 Hz and the second operating frequency is 1 Hz, a data signal corresponding to the first image IM1 may be provided in the first display area DA1 of the electronic device ED for one second in each of the first to 120th frames F1 to F120. A data signal corresponding to the second image IM2 may be provided to the second display area DA2 during only the first frame F1. That is, because a new data signal is not provided to the second display area DA2 during the second to 120th frames F2 to F120, the second image IM2 the same as the second image IM2 during the first frame F1 may be displayed on the electronic device ED during the second to 120th frames F2 to F120.

FIG. 4C illustrates an operation of the electronic device ED in the multi-frequency mode MFM where the first operating frequency is 120 Hz and the second operating frequency is 1 Hz, but the present disclosure is not limited thereto. The second operating frequency may be variously changed to a frequency lower than the first operating frequency, for example, 60 Hz, 30 Hz, 10 Hz, or the like.

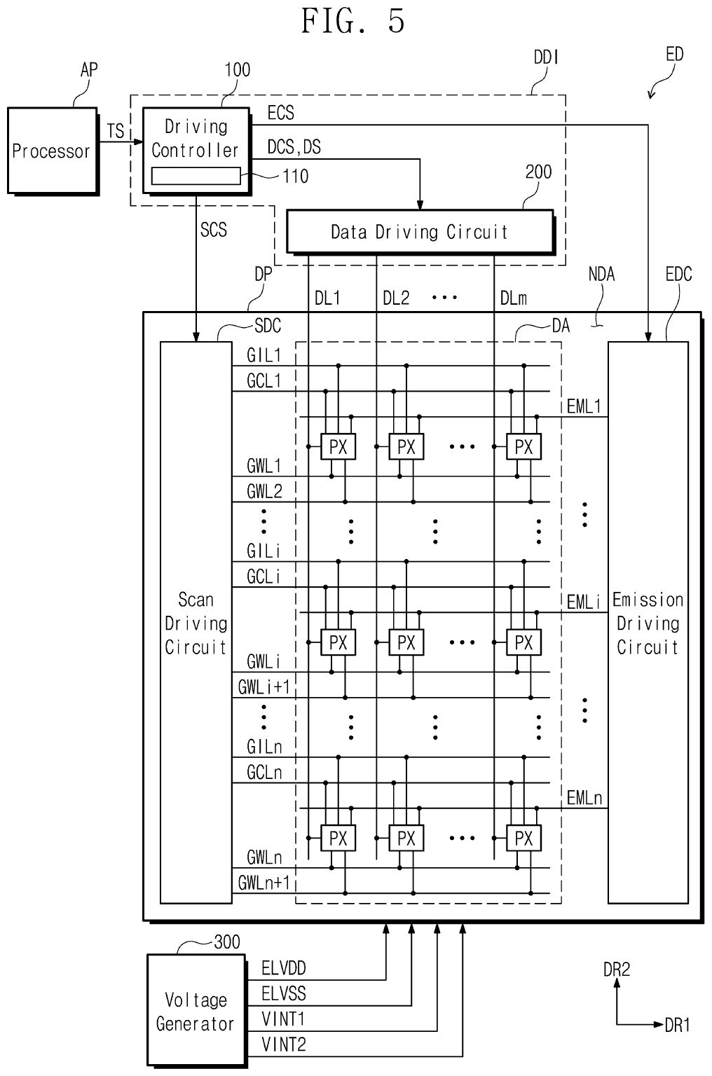

FIG. 5 is a block diagram of the electronic device ED, according to an embodiment of the present disclosure.

Referring to FIG. 5, an embodiment of the electronic device ED includes a processor AP, a driving circuit DDI, a display panel DP, and a voltage generator 300.

The processor AP may be one of an application processor, a graphic processor, a main processor, or a central processing unit (CPU). The driving circuit DDI includes a driving controller 100 and a data driving circuit 200. In an embodiment, the driving controller 100 and the data driving circuit 200 may be implemented in one chip (or in a same single chip), but the present disclosure is not limited thereto.

The processor AP provides a transmission signal TS to the driving controller 100.

The driving controller 100 operates in response to the transmission signal TS from the processor AP. The driving controller 100 converts the image signal included in the transmission signal TS into an image data signal DS and outputs the image data signal DS. The driving controller 100 outputs a scan control signal SCS, a data control signal DCS, and an emission control signal ECS in response to a control signal included in the transmission signal TS.

In an embodiment, the driving controller 100 includes a memory 110. The driving controller 100 may store the image data signal DS in the memory 110.

The data driving circuit 200 receives the data control signal DCS and the image data signal DS from the driving controller 100. The data driving circuit 200 converts the image data signal DS into data signals and then outputs the data signals to a plurality of data lines DL1 to DLm to be described later.

The voltage generator 300 generates voltages used to operate the display panel DP. In an embodiment, the voltage generator 300 generates a first driving voltage ELVDD, a second driving voltage ELVSS, a first initialization voltage VINT1, and a second initialization voltage VINT2.

The display panel DP includes scan lines GIL1 to GILn, GCL1 to GCLn, and GWL1 to GWLn+1, emission control lines EML1 to EMLn, the data lines DL1 to DLm, and pixels PX. The display panel DP may further include a scan driving circuit SDC and an emission driving circuit EDC. In an embodiment, the scan driving circuit SDC is arranged on a first side of the display panel DP. The scan lines GIL1 to GILn, GCL1 to GCLn, and GWL1 to GWLn+1 extend from the scan driving circuit SDC in the first direction DR1.

The emission driving circuit EDC is arranged on a second side of the display panel DP. The emission control lines EML1 to EMLn extend from the emission driving circuit EDC in a direction opposite to the first direction DR1.

The scan lines GIL1 to GILn, GCL1 to GCLn, and GWL1 to GWLn+1 and the emission control lines EML1 to EMLn are arranged spaced from one another in the second direction DR2. The data lines DL1 to DLm extend from the data driving circuit 200 in a direction opposite to the second direction DR2, and are arranged spaced from one another in the first direction DR1. Here, n and m are natural numbers greater than 1.

In an embodiment, as shown in FIG. 5, the scan driving circuit SDC and the emission driving circuit EDC are arranged to face each other with the pixels PX interposed therebetween, but the present disclosure is not limited thereto. In another embodiment, for example, the scan driving circuit SDC and the emission driving circuit EDC may be disposed adjacent to each other in the non-display area NDA of the display panel DP. In an embodiment, the scan driving circuit SDC and the emission driving circuit EDC may be implemented with one circuit or a single circuitry.

The plurality of pixels PX are electrically connected to the scan lines GIL1 to GILn, GCL1 to GCLn, and GWL1 to GWLn+1, the emission control lines EML1 to EMLn, and the data lines DL1 to DLm. Each of the plurality of pixels PX may be electrically connected to four scan lines and one emission control line. In an embodiment, for example, as shown in FIG. 4, a first row of pixels may be connected to the scan lines GIL1, GCL1, GWL1, and GWL2 and the emission control line EML1. The i-th row of pixels may be connected to the scan lines GILi, GCLi, GWLi, and GWLi+1 and the emission control line EMLi. The n-th row of pixels may be connected to the scan lines GILn, GCLn, GWLn, and GWLn+1 and the emission control line EMLn.

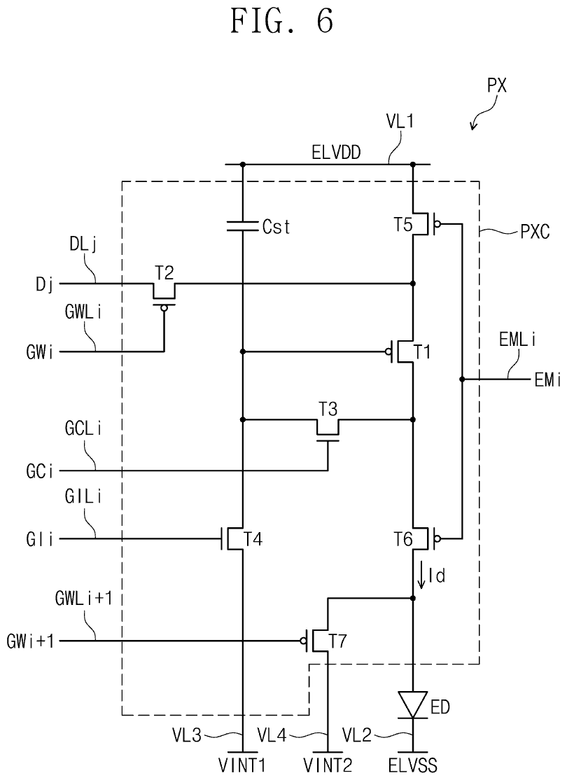

Each of the plurality of pixels PX includes a light emitting element ED (see FIG. 6) and a pixel circuit PXC (see FIG. 6) for controlling the emission of the light emitting element ED. The pixel circuit PXC may include one or more transistors and one or more capacitors. The scan driving circuit SDC and the emission driving circuit EDC may include transistors formed through a same process as the pixel circuit PXC.

Each of the plurality of pixels PX receives the first driving voltage ELVDD, the second driving voltage ELVSS, the first initialization voltage VINT1, and the second initialization voltage VINT2 from the voltage generator 300.

The scan driving circuit SDC receives the scan control signal SCS from the driving controller 100. The scan driving circuit SDC may output scan signals to the scan lines GIL1 to GILn, GCL1 to GCLn, and GWL1 to GWLn+1 in response to the scan control signal SCS.

The driving controller 100 according to an embodiment may determine an operating mode based on information included in the transmission signal TS. In an embodiment, the driving controller 100 may determine the operating mode as one of a normal mode, a still-image mode, and a multi-frequency mode based on information included in the transmission signal TS.

When the determined operating mode is the still-image mode, the driving controller 100 may perform self-refresh on an image displayed on the display panel DP by using the image signal stored in the memory 110.

When the determined operating mode is the multi-frequency mode, the driving controller 100 may divide the display panel DP into a plurality of display areas and may drive the plurality of display areas at different operating frequencies.

The detailed operation of the driving controller 100 will be described in detail later.

FIG. 6 is a circuit diagram of a pixel PX, according to an embodiment of the present disclosure.

FIG. 6 illustrates an equivalent circuit diagram of the pixel PX connected to the j-th data line DLj among the data lines DL1 to DLm, the i-th scan lines GILi, GCLi, and GWLi and the (i+1)-th scan line GWLi+1 among the scan lines GIL1 to GILn, GCL1 to GCLn, and GWL1 to GWLn+1, and the i-th emission control line EMLi among the emission control lines EML1 to EMLn, which are illustrated in FIG. 5. Here, i is a natural number greater less than or equal to n, and j is a natural number greater less than or equal to m.

Each of the plurality of pixels PX shown in FIG. 5 may have the same circuit configuration as the pixel PX shown in FIG. 6.

Referring to FIG. 6, the pixel PX according to an embodiment includes the pixel circuit PXC and the at least one light emitting element ED. In an embodiment, the light emitting element ED may be a light emitting diode. In an embodiment, it is described that the one pixel PX includes the one light emitting element ED. The pixel circuit PXC includes first to seventh transistors T1, T2, T3, T4, T5, T6, and T7 and a capacitor Cst.

In an embodiment, the third and fourth transistors T3 and T4 among the first to seventh transistors T1 to T7 are N-type transistors by using an oxide semiconductor as a semiconductor layer. Each of the first, second, fifth, sixth, and seventh transistors T1, T2, T5, T6, and T7 is a P-type transistor having a low-temperature polycrystalline silicon (LTPS) semiconductor layer. However, the present disclosure is not limited thereto. In an embodiment, for example, all of the first to seventh transistors T1 to T7 may be P-type transistors or N-type transistors. In an embodiment, at least one of the first to seventh transistors T1 to T7 may be an N-type transistor, and the other(s) thereof may be P-type transistors. Moreover, the circuit configuration of a pixel according to an embodiment of the present disclosure is not limited to an embodiment of FIG. 6. A configuration of the pixel circuit PXC illustrated in FIG. 6 may be modified and implemented.

The scan lines GILi, GCLi, GWLi, and GWLi+1 may transmit scan signals Gli, GCi, GWi, and GWi+1, respectively. The emission control line EMLi may transmit an emission control signal EMi. The data line DLj may transmit a data signal Dj. The data signal Dj may have a voltage level corresponding to the image signal RGB input to the electronic device ED (see FIG. 5). First to fourth driving voltage lines VL1, VL2, VL3, and VL4 may transmit the first driving voltage ELVDD, the second driving voltage ELVSS, the first initialization voltage VINT1, and the second initialization voltage VINT2, respectively.

The first transistor T1 includes a first electrode connected to the first driving voltage line VL1 via the fifth transistor T5, a second electrode electrically connected to an anode of the light emitting element ED via the sixth transistor T6, and a gate electrode connected to one end of the capacitor Cst. The first transistor T1 may receive the data signal Dj transmitted through the data line DLj based on the switching operation of the second transistor T2 and then may supply a driving current Id to the light emitting element ED.

The second transistor T2 includes a first electrode connected to the data line DLj, a second electrode connected to the first electrode of the first transistor T1, and a gate electrode connected to the scan line GWLi. The second transistor T2 may be turned on in response to the scan signal GWi transmitted through the scan line GWLi and may transfer the data signal Dj transmitted through the data line DLj to the first electrode of the first transistor T1.

The third transistor T3 includes a first electrode connected with the gate electrode of the first transistor T1, a second electrode connected with the second electrode of the first transistor T1, and a gate electrode connected with the scan line GCLi. The third transistor T3 may be turned on in response to the scan signal GCi transmitted through the scan line GCLi, and thus, the gate electrode and the second electrode of the first transistor T1 may be connected, that is, the first transistor T1 may be diode-connected.

The fourth transistor T4 includes a first electrode connected with the gate electrode of the first transistor T1, a second electrode connected with the third driving voltage line VL3 through which the first initialization voltage VINT1 is transmitted, and a gate electrode connected with the scan line GILi. The fourth transistor T4 may be turned on in response to the scan signal Gli transmitted through the scan line GILi such that the first initialization voltage VINT1 is transmitted to the gate electrode of the first transistor T1. Accordingly, an initialization operation of initializing a voltage of the gate electrode of the first transistor T1 may be performed.

The fifth transistor T5 includes a first electrode connected to the first driving voltage line VL1, a second electrode connected to the first electrode of the first transistor T1, and a gate electrode connected to the emission control line EMLi.

The sixth transistor T6 includes a first electrode connected to the second electrode of the first transistor T1, a second electrode connected with the anode of the light emitting element ED, and a gate electrode connected with the emission control line EMLi.

The fifth transistor T5 and the sixth transistor T6 may be simultaneously turned on in response to the emission control signal EMi transmitted through the emission control line EMLi. In this way, the first driving voltage ELVDD may be compensated for through the diode-connected transistor T1 so as to be supplied to the light emitting element ED.

The seventh transistor T7 includes a first electrode connected to the second electrode of the sixth transistor T6, a second electrode connected to the fourth driving voltage line VL4, and a gate electrode connected to the scan line GWLi+1. The seventh transistor T7 is turned on in response to the scan signal GWi+1 transmitted through the scan line GWLi+1 and bypasses a current of the anode of the light emitting element ED to the fourth voltage line VL4.

In an embodiment, as described above, one end of the capacitor Cst is connected to the gate electrode of the first transistor T1, and another end of the capacitor Cst is connected to the first driving voltage line VL1. The cathode of the light emitting element ED may be connected to the second driving voltage line VL2, to which the second driving voltage ELVSS is applied. The structure of the pixel PX according to an embodiment is not limited to the structure illustrated in FIG. 6. In an embodiment, for example, the number of transistors included in the one pixel PX, the number of capacitors included in the pixel PX, and the connection relationship between the transistors and the capacitors may be variously modified.

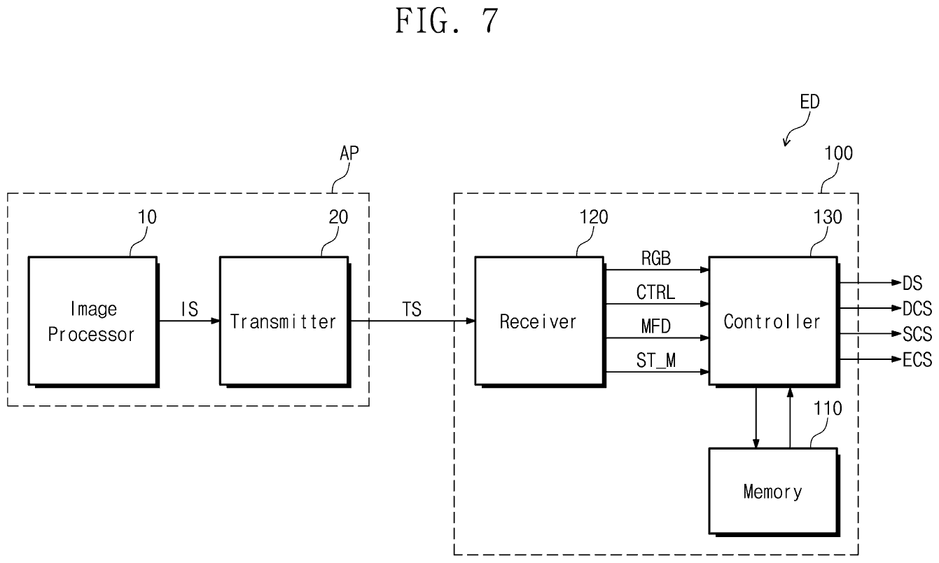

FIG. 7 is a block diagram showing a configuration of the processor AP and the driving controller 100 of the electronic device ED.

Referring to FIG. 7, in an embodiment, the processor AP includes an image processor 10 and a transmitter 20. The image processor 10 determines an operating mode of the electronic device ED (see FIG. 5) and generates an image control signal IS corresponding to the operating mode. The transmitter 20 converts the image control signal IS into the transmission signal TS and outputs the transmission signal TS.

In an embodiment, the processor AP may output the transmission signal TS of a type suitable for an interface between the processor AP and the driving controller 100. In an embodiment, the interface between the processor AP and the driving controller 100 may be a mobile industry processor interface (MIPI).

A receiver 120 receives the transmission signal TS provided from the processor AP. The receiver 120 restores the image signal RGB, a control signal CTRL, a multi-frequency mode signal MFD, and a still-image mode signal ST_M, which are included in the transmission signal TS.

A controller 130 outputs the image data signal DS, the data control signal DCS, the scan control signal SCS, and the emission control signal ECS based on the image signal RGB, the control signal CTRL, the multi-frequency mode signal MFD and the still-image mode signal ST_M.

When the still-image mode signal ST_M is at a first level, the controller 130 may write the image data signal DS to the memory 110 or may read out the image data signal DS stored in the memory 110.

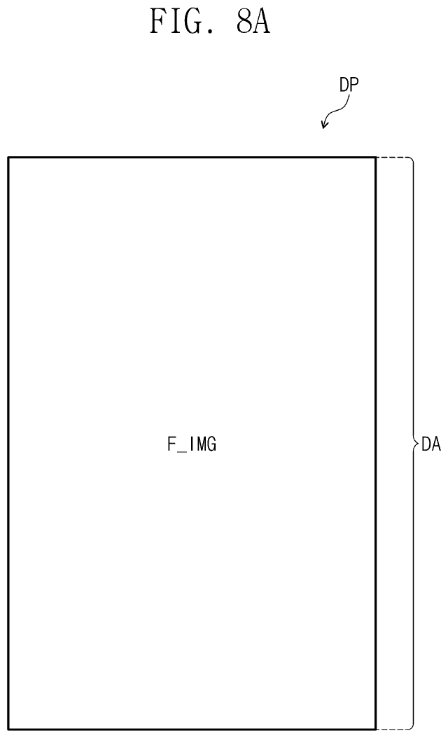

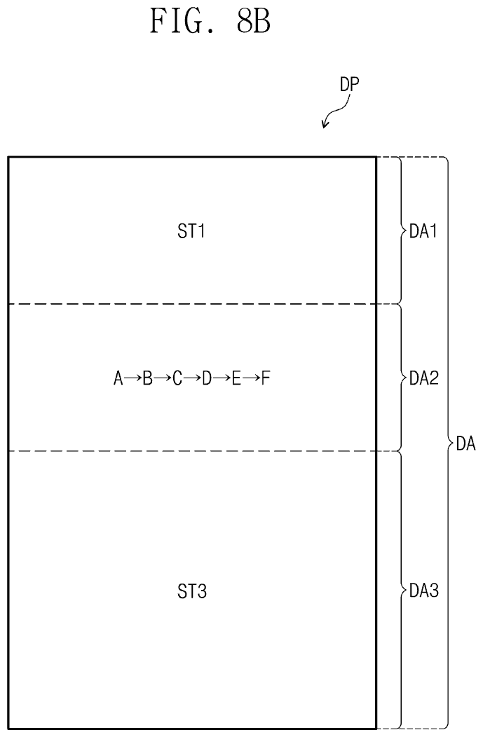

FIG. 8A is a drawing showing an image displayed on the display panel DP in a normal mode.

FIG. 8B is a drawing showing an image displayed on the display panel DP in a multi-frequency mode.

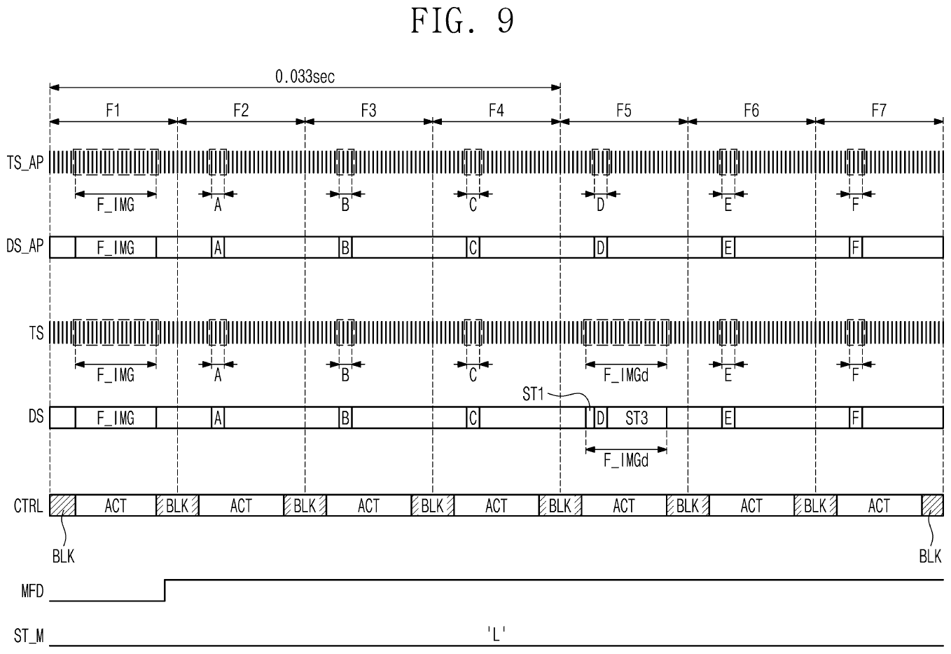

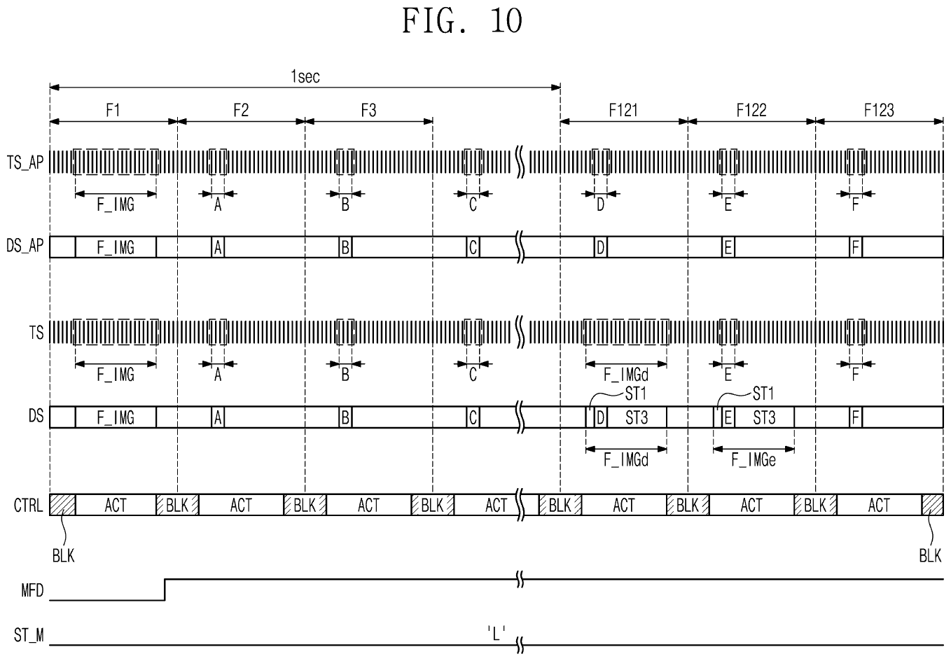

FIGS. 9 and 10 are drawings for describing operations of the processor AP and the driving controller 100 in a normal mode and a multi-frequency mode.

Referring to FIGS. 7, 8A, and 9, a first plan signal TS_AP and a second plan signal DS_AP are signals for predicting the transmission signal TS and the image data signal DS when the image processor 10 in the processor AP determines an operating mode. The first plan signal TS_AP and the second plan signal DS_AP may differ from the actual transmission signal TS and the actual image data signal DS.

During a first frame F1, during which both the multi-frequency mode signal MFD and the still-image mode signal ST_M are at low levels (i.e., inactive levels), the electronic device ED operates in a normal mode. As illustrated in FIG. 8A, in the normal mode, a full image F_IMG is displayed in the display area DA of the display panel DP. In the normal mode, the transmission signal TS corresponds to the full image F_IMG. The image data signal DS output from the controller 130 corresponds to the full image F_IMG in the same way as the transmission signal TS.

The control signal CTRL included in the transmission signal TS includes a blank period BLK and an active period ACT. The controller 130 may control the data driving circuit 200, the scan driving circuit SDC, and the emission driving circuit EDC, which are illustrated in FIG. 5, during the active period ACT such that an image corresponding to the image data signal DS is displayed on the display panel DP.

Referring to FIGS. 7, 8B, and 9, during second to seventh frames F2, F3, F4, F5, F6, and F7, during which the multi-frequency mode signal MFD is at a high level (i.e., an active level) and the still-image mode signal ST_M is at a low level, the electronic device ED operates in a multi-frequency mode.

While the still-image mode signal ST_M is at a low level (i.e., an inactive level), the memory 110 is maintained in an off state, in which it is not in operation.

In the multi-frequency mode, the full image F_IMG is displayed in the display area DA of the display panel DP. As illustrated in FIG. 8B, in the multi-frequency mode, the display area DA of the display panel DP may be divided into the first display area DA1, the second display area DA2, and the third display area DA3. Images ST1 and ST3 respectively displayed in the first display area DA1 and the third display area DA3 are still images, and images ‘A’, ‘B’, ‘C’, ‘D’, ‘E’, and ‘F’ displayed in the second display area DA2 are a video. The images ‘A’, ‘B’, ‘C’, ‘D’, ‘E’, and ‘F’ may be displayed sequentially in the second display area DA2 during each of the second to seventh frames F2, F3, F4, F5, F6, and F7. In an embodiment, it will be understood that the images ST1 and ST3 displayed in the first display area DA1 and the third display area DA3 are identical to a part of the full image F_IMG displayed in the first frame F1 as illustrated in FIG. 8A.

Because the images ST1 and ST3 respectively corresponding to the first display area DA1 and the third display area DA3 are not changed in the multi-frequency mode, the processor AP may predict the first plan signal TS_AP and the second plan signal DS_AP to provide the driving controller 100 with only signals corresponding to the images ‘A’, ‘B’, ‘C’, ‘D’, ‘E’, and ‘F’ to be displayed in the second display area DA2 during each of the second to seventh frames F2, F3, F4, F5, F6, and F7.

During each of the second, third, and fourth frames F2, F3, and F4, the transmission signal TS and the image data signal DS may be identical to the first plan signal TS_AP and the second plan signal DS_AP.

The processor AP may include information about a start location of each of the first display area DA1, the second display area DA2, and the third display area DA3 in the transmission signal TS and may transmit the information.

The controller 130 may control the data driving circuit 200, the scan driving circuit SDC and the emission driving circuit EDC illustrated in FIG. 5 in a way such that the images ‘A’, ‘B’, and ‘C’ are respectively displayed in the second display area DA2 during the second, third, and fourth frames F2, F3, and F4.

The pixels PX (see FIG. 6) of the first display area DA1 and the third display area DA3 may display an image corresponding to the data signal Dj (i.e., the data signal Dj stored in the first frame F1) stored in the capacitor Cst.

When either the operating frequency of the first display area DA1 or the operating frequency of the third display area DA3 is 30 Hz, the image data signal DS output from the first display area DA1 and the third display area DA3 may be refreshed every 1/30 seconds (i.e., 0.033 seconds). When the operating frequency of the second display area DA2 is 120 Hz, the processor AP provides the driving controller 100 with the transmission signal TS corresponding to a full image F_IMGd of the display area DA in the fifth frame F5.

The images ST1 and ST3 displayed in the first display area DA1 and the third display area DA3 are still images, and thus the images ST1 and ST3 in the full image F_IMGd during the fifth frame F5 are the same as images during the previous frames F1, F2, F3, and F4. Because the image ‘D’ corresponding to the second display area DA2 is a new image, the full image F_IMGd includes the images ST1, ‘D’, and ST3.

The processor AP may provide the driving controller 100 with only signals respectively corresponding to the images E and F to be displayed in the second display area DA2 in the sixth and seventh frames F6 and F7 of the multi-frequency mode.

The controller 130 may control the data driving circuit 200, the scan driving circuit SDC and the emission driving circuit EDC illustrated in FIG. 5 such that the images ‘E’ and ‘F’ are respectively displayed in the second display area DA2 during the sixth and seventh frames F6 and F7.

The operation of the electronic device ED in the first, second, and third frames F1, F2, and F3 illustrated in FIG. 10 is the same as that illustrated in FIG. 9, and thus any repetitive detailed description thereof will be omitted.

Referring to FIGS. 7, 8B, and 10, when either the operating frequency of the first display area DA1 or the operating frequency of the third display area DA3 is 1 Hz, the image data signal DS output from the first display area DA1 and the third display area DA3 may be refreshed every 1 second. When the operating frequency of the second display area DA2 is 120 Hz, the processor AP provides the driving controller 100 with the transmission signal TS corresponding to the full image F_IMGd of the display area DA in a 121st frame F121.

The images ST1 and ST3 displayed in the first display area DA1 and

the third display area DA3 are still images, and thus the images ST1 and ST3 in the full image F_IMGd during the 121st frame F121 are the same as images during the previous frames F1, F2, and F3. Because the image ‘D’ corresponding to the second display area DA2 is a new image, the full image F_IMGd includes the images ST1, ‘D’, and ST3.

When the operating frequency of each of the first display area DA1 and the third display area DA3 is low, the amount of charge stored in the capacitor Cst in the pixel PX (FIG. 6) decreases due to leakage current, etc., which may reduce the display quality of the image displayed on the display panel DP.

In a case where the operating frequency of each of the first display area DA1 and the third display area DA3 in the multi-frequency mode is lower than a reference frequency (e.g., 10 Hz), when updating images of the first display area DA1 and the third display area DA3, the processor AP may repeatedly and additionally update images corresponding to 1 or 2 frames.

In other words, to update the images of the first display area DA1 and the third display area DA3 in a 122nd frame F122 continuous with the 121st frame F121 once more, the processor AP outputs the transmission signal TS corresponding to a full image F_IMGe. The full image F_IMGe includes images ST1, ‘E’, and ST3.

The processor AP may provide the driving controller 100 with only signals corresponding to the image ‘F’ to be displayed in the second display area DA2 in a 123rd frame F123.

The controller 130 may control the data driving circuit 200, the scan driving circuit SDC and the emission driving circuit EDC illustrated in FIG. 5 in a way such that the image ‘F’ is displayed in the second display area DA2 in the 123rd frame F123.

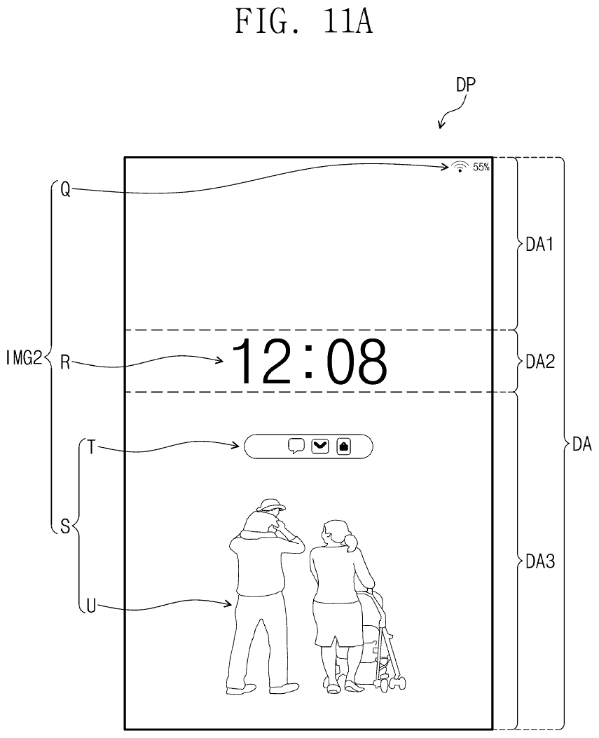

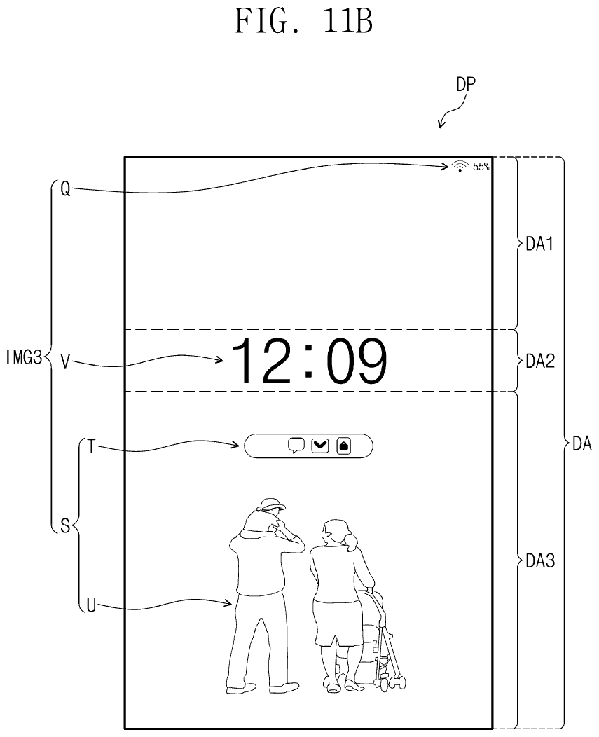

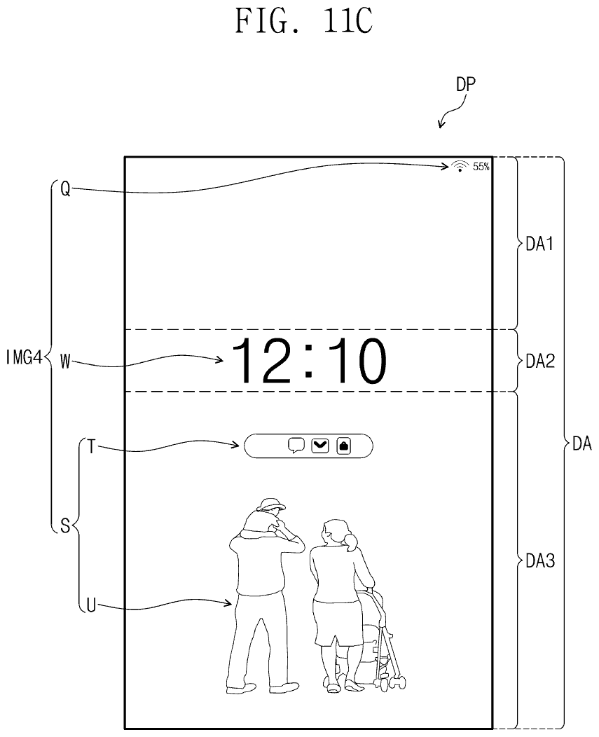

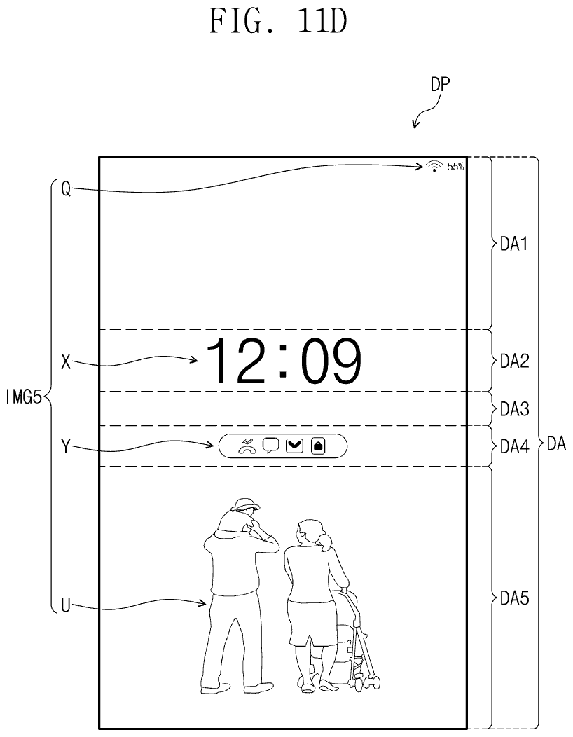

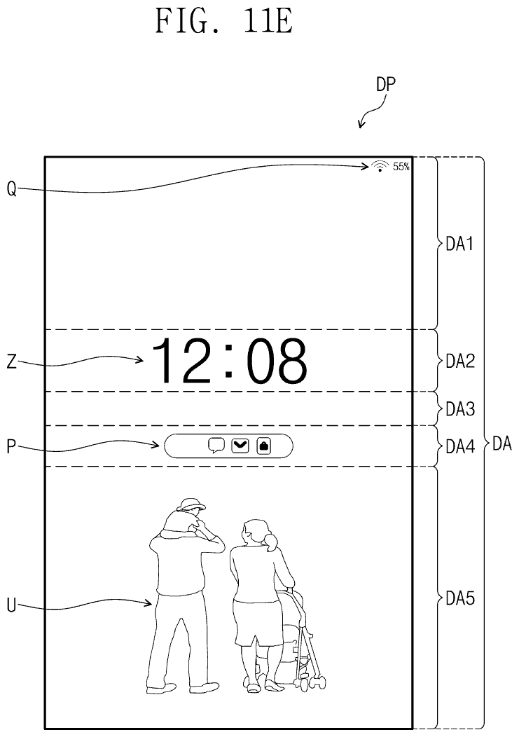

FIGS. 11A, 11B, 11C, 11D, and 11E are drawings showing images displayed on the display panel DP in a still-image mode.

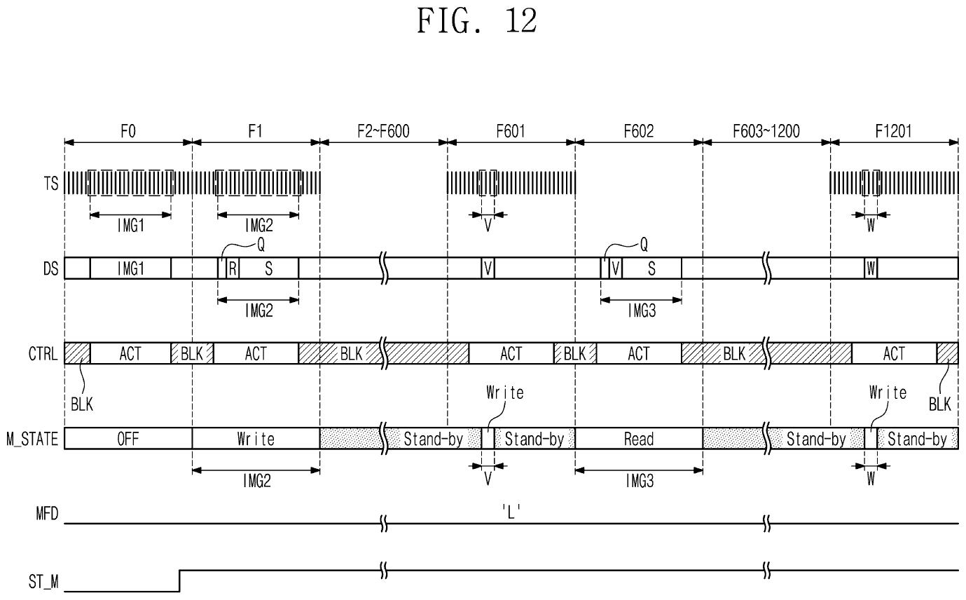

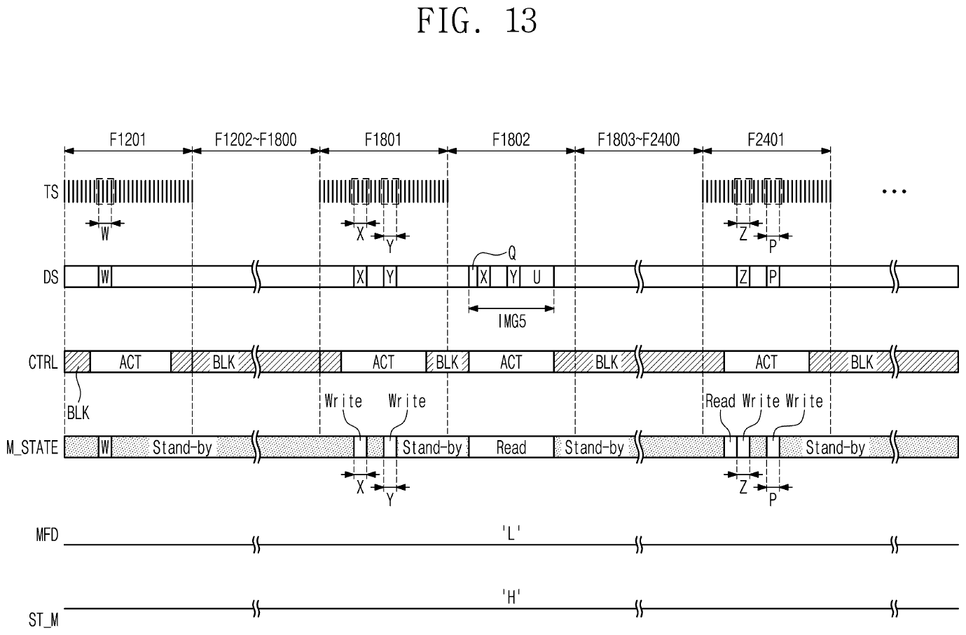

FIGS. 12 and 13 are drawings for describing operations of the processor AP and the driving controller 100 in a still-image mode.

Referring to FIG. 12, during the 0th frame F0, during which both the multi-frequency mode signal MFD and the still-image mode signal ST_M are at low levels, the electronic device ED operates in a normal mode. In the normal mode, the processor AP provides the driving controller 100 with the transmission signal TS corresponding to a full image IMG1. During the active period ACT of the control signal CTRL, the driving controller 100 may provide the data driving circuit 200 with the image data signal DS corresponding to the full image IMG1.

In FIGS. 12 and 13, a memory state signal M_STATE indicates the operating state of the memory 110. During the 0th frame F0, which is in a normal mode, the memory 110 is maintained in an off state OFF, where it is not in operation.

Referring to FIGS. 7 and 12, when the multi-frequency mode signal MFD is at a low level and the still-image mode signal ST_M is at a high level (i.e., active level), the electronic device ED operates in a still-image mode from the first frame F1.

As illustrated in FIG. 11A, in the still-image mode, the display area DA of the display panel DP may be divided into first, second, and third display areas DA1, DA2, and DA3. A full image IMG2 displayed in the display area DA includes images ‘Q’, ‘R’, and ‘S’. The image ‘S’ includes images ‘T’ and ‘U’. In an embodiment, the images ‘Q’, ‘R’, and ‘S’ are displayed in the first, second and third display areas DA1, DA2, and DA3, respectively. The full image IMG2 displayed on the display panel DP in the still-image mode may include a still image such as a photograph or text information.

During a first frame F1, which is a start or initial frame of the still-image mode, the processor AP provides the driving controller 100 with the transmission signal TS corresponding to the full image IMG2. The driving controller 100 may provide the data driving circuit 200 with the image data signal DS corresponding to the full image IMG2.

In the first frame F1, the controller 130 in the driving controller 100 writes, to the memory 110, the image data signal DS corresponding to the full image IMG2 in the first frame F1 that is the start of the still-image mode. In this case, the memory state signal M_STATE indicates that the memory 110 is in a write state Write.

During the second to 600th frames F2 to F600 during which the full image IMG2 shown in FIG. 11A is maintained, the processor AP does not transmit the transmission signal TS. In other words, when the full image IMG2 of the previous frame is the same as the full image IMG2 of the current frame, the processor AP does not transmit the transmission signal TS.

Because the transmission signal TS corresponding to a new image is not received during the second to 600th frames F2 to F600, the driving controller 100 may be maintained in the blank period BLK, where the image data signal DS is not output, and the control signal CTRL is not output. The memory state signal M_STATE indicates that the memory 110 is in a stand-by state where the memory 110 does not perform write or read operations. During the second to 600th frames F2 to F600, the transmission signal TS may be maintained at a high level or low level.

As illustrated in FIG. 11B, the processor AP provides the driving controller 100 with the transmission signal TS corresponding to the new image ‘V’ such that the new image ‘V’ is displayed in the second display area DA2 in the 601st frame F601. The driving controller 100 may provide the data driving circuit 200 with the image data signal DS corresponding to the image ‘V’.

In the 601 st frame F601, the controller 130 in the driving controller 100 writes, to the memory 110, the image data signal DS corresponding to the image ‘V’. In this case, the memory state signal M_STATE indicates that the memory 110 is in the write state Write. In this way, even in the still-image mode, only the image corresponding to a part of the display panel DP may be updated to a new image. Moreover, some updated images may be stored in the memory 110.

The memory 110 may store the images ‘Q’ and ‘S’ of the full image IMG2 stored in the first frame F1, and the image data signal DS corresponding to the new image ‘V’. That is, the image data signal DS corresponding to a full image IMG3 may be stored in the memory 110.

In an embodiment, as shown in FIGS. 11B and 12, still images (i.e., the images ‘Q’ and ‘S’) displayed in the first and third display areas DA1 and DA3 do not change during the second to 600th frames F2 to F600. When the display time of a still image in the still-image mode reaches a predetermined time, the controller 130 may refresh an image displayed on the display panel DP. In an embodiment, for example, the controller 130 may refresh the image displayed on the display panel DP every 600 frames.

In an embodiment, the controller 130 may refresh the image data signal DS during the next frame after a new image is received. As shown in FIG. 12, when the transmission signal TS corresponding to the new image ‘V’ is received in a 601st frame F601, the full image IMG3 stored in the memory 110 may be read out in a 602nd frame F602 and then the image data signal DS may be refreshed. The 602nd frame F602 may be a refresh frame.

A time point, at which the controller 130 reads out the full image IMG3 stored in the memory 110 and refreshes the image data signal DS, or a refresh cycle may be changed in various ways.

As illustrated in FIG. 11C, the processor AP provides the driving controller 100 with the transmission signal TS corresponding to a new image ‘W’ such that the new image ‘W’ is displayed in the second display area DA2 in the 1201st frame F1201. The driving controller 100 may provide the data driving circuit 200 with the image data signal DS corresponding to the new image ‘W’.

In the 1201st frame F1201, the controller 130 in the driving controller 100 writes, to the memory 110, the image data signal DS corresponding to the new image ‘W’. In this case, the memory state signal M_STATE indicates that the memory 110 is in the write state Write.

The image data signal DS corresponding to the new image ‘W’ may be stored in the memory 110. That is, the image data signal DS corresponding to a full image IMG4 may be stored in the memory 110.

The 1201st frame F1201 illustrated in FIG. 13 is the same as the 1201st frame F1201 illustrated in FIG. 12, and thus any repetitive detailed description thereof will be omitted.

During the 1202 to 1800th frames F1202 to F1800 during which the full image IMG4 shown in FIG. 11C is maintained, the processor AP does not transmit the transmission signal TS.

Referring to FIGS. 7, 11D, and 13, in a 1801st frame F1801, the processor AP divides the display panel DP into first, second, third, fourth, and fifth display areas DA1, DA2, DA3, DA4, and DA5. The processor AP provides the driving controller 100 with the transmission signal TS corresponding to new images ‘X’ and ‘Y’ such that the images ‘X’ and ‘Y’ are displayed on the second display area DA2 and the fourth display area DA4. The driving controller 100 may provide the data driving circuit 200 with the image data signal DS corresponding to the new images ‘X’ and ‘Y’.

In the 1801st frame F1801, the controller 130 in the driving controller 100 writes, to the memory 110, the image data signal DS corresponding to the new images ‘X’ and ‘Y’. In this case, the memory state signal M_STATE indicates that the memory 110 is in the write state Write. In this way, even in the still-image mode, only the image corresponding to a part of the display panel DP may be updated to a new image. Moreover, some updated images may be stored in the memory 110.

The image data signal DS corresponding to the images ‘Q’, ‘X’, ‘Y’, and ‘U’ may be stored in the memory 110. That is, the image data signal DS corresponding to a full image IMG5 may be stored in the memory 110.

When it is determined that the still-image mode continues for a long time, the controller 130 may refresh the image displayed on the display panel DP.

In an embodiment, the controller 130 may refresh the image data signal DS during the next frame after a new image is received. In an embodiment, for example, as shown in FIG. 13, when the transmission signal TS corresponding to the new images ‘X’ and ‘Y’ is received in the 1801st frame F1801, the full image IMG5 stored in the memory 110 may be read out in a 1802nd frame F1802 and then the image data signal DS may be refreshed.

A time point, at which the controller 130 reads out the full image IMG5 stored in the memory 110 and refreshes the image data signal DS, or a refresh cycle may be changed in various ways.

During the 1803rd to 2400th frames F1803 to F2400 during which the full image IMG4 shown in FIG. 11D is maintained, the processor AP does not transmit the transmission signal TS.

Referring to FIGS. 7, 11E, and 13, when the display time of a still image in the still-image mode reaches a predetermined time, the controller 130 reads out the image data signal DS corresponding to the full image from the memory 110. In this case, the memory state signal M_STATE indicates that the memory 110 is in a read state Read. When the processor AP transmits the transmission signal TS corresponding to new images ‘Z’ and ‘P’ while reading the image data signal DS corresponding to the full image from the memory 110, the controller 130 may stop an operation of reading out the image data signal DS from the memory 110 and may provide the data driving circuit 200 with the image data signal DS corresponding to the new images ‘Z’ and ‘P’.
when the display time of the still image in the still-image mode reaches the predetermined time, the controller 130 in the driving controller 100 writes, to the memory 110, the image data signal DS corresponding to the new images ‘Z’ and ‘P’. In this case, the memory state signal M_STATE indicates that the memory 110 is in the write state Write. In this way, even in the still-image mode, only the image corresponding to a part of the display panel DP may be updated to a new image. Moreover, some updated images may be stored in the memory 110.

The invention should not be construed as being limited to the embodiments set forth herein. Rather, these embodiments are provided so that this disclosure will be thorough and complete and will fully convey the concept of the invention to those skilled in the art.

A processor of an electronic device having such a configuration may transmit a transmission signal including information (e.g., a multi-frequency mode and a still-image mode) and an image signal to a driving circuit. A driving circuit of the electronic device may operate in the multi-frequency mode and the still-image mode depending on the information provided from the processor.

The electronic device may minimize power consumption by lowering the operating frequency of part or all of a display panel in the multi-frequency mode and the still-image mode.

The driving circuit of the electronic device may store an image signal in a memory therein in the still-image mode. The driving circuit may read the image signal stored in the memory and may output the image signal to a data driving circuit when determining that self-refresh is desired in the still-image mode.

The operating frequency of the electronic device may be lowered in the still-image mode. Display quality may be effectively prevented from being degraded by providing the image signal stored in the memory to the display panel as desired.

While the invention has been particularly shown and described with reference to embodiments thereof, it will be understood by those of ordinary skill in the art that various changes in form and details may be made therein without departing from the spirit or scope of the invention as defined by the following claims.

What is claimed is:

1. An electronic device comprising:
a display panel;
a processor which outputs a transmission signal; and
a driving controller which receives the transmission signal and outputs an image data signal based on the transmission signal in a way such that an image is displayed on the display panel,
wherein the driving controller includes a memory which stores the image data signal,
wherein the processor
outputs the transmission signal when a current image corresponding to a part of the display panel is different from a previous image corresponding to the part of the display panel in a still-image mode, and
wherein
when a display time of a still image corresponding to the part of the display panel reaches a predetermined time in the still-image mode, the driving controller allows the display panel to be refreshed by the image data signal read from the memory.

2. The electronic device of claim 1, wherein when the current image corresponding to the part of the display panel is different from the previous image corresponding to the part of the display panel, the processor outputs the transmission signal corresponding to the part of the display panel, and
wherein the driving controller stores the image data signal corresponding to the part of the display panel in the memory.

3. The electronic device of claim 1, wherein during a refresh frame of the still-image mode, the driving controller reads out the image data signal corresponding to a full image of the display panel from the memory and outputs the image data signal corresponding to the full image to the display panel.

4. The electronic device of claim 3, wherein the driving controller sets a next frame as the refresh frame after the transmission signal corresponding to a new image is received in the still-image mode.

5. The electronic device of claim 1, wherein when the still-image mode starts, the processor outputs the transmission signal corresponding to a full image of the display panel to the driving controller.

6. The electronic device of claim 5, wherein when the full image of a current frame is identical to the full image of a previous frame in the still-image mode, the processor does not output the transmission signal.

7. The electronic device of claim 1, wherein the transmission signal includes a still-image mode signal indicating the still-image mode, and
wherein the driving controller restores the still-image mode signal included in the transmission signal.

8. The electronic device of claim 7, wherein the driving controller further includes:
a receiver which restores an image signal, a multi-frequency mode signal, and the still-image mode signal based on the transmission signal, wherein the image signal, the multi-frequency mode signal, and the still-image mode signal are included in the transmission signal; and
a controller which converts the image signal into the image data signal, and
wherein when the display time of the still image reaches the predetermined time while the still-image mode signal is at an active level, the controller outputs the image data signal read from the memory.

9. The electronic device of claim 8, wherein when the multi-frequency mode signal is at the active level, the controller outputs the image data signal corresponding to the transmission signal.

10. The electronic device of claim 8, wherein when the multi-frequency mode signal is at the active level and the still-image mode signal is at an inactive level, the memory is maintained in an off state.

11. The electronic device of claim 1, wherein when the display time of the still image corresponding to the part of the display panel reaches the predetermined time in a multi-frequency mode, the processor outputs the transmission signal corresponding to a full image of the display panel to the driving controller and the driving controller allows the display panel to be refreshed.

12. The electronic device of claim 1, wherein during a first frame where the still-image mode starts, the processor outputs the transmission signal corresponding to a full image of the display panel to the driving controller, and
wherein in the first frame where the still-image mode starts, the driving controller stores the image data signal corresponding to the transmission signal in the memory.

13. An electronic device comprising:
a display panel;
a processor which outputs a transmission signal; and
a driving controller which receives the transmission signal and outputs an image data signal based on the transmission signal in a way such that an image is displayed on the display panel,
wherein the driving controller includes a memory which stores the image data signal,
wherein the processor
divides the display panel into a first display area and a second display area in a still-image mode, and outputs the transmission signal when a current image corresponding to the second display area is different from a previous image corresponding to the second display area, and
wherein
when a display time of a still image corresponding to the first display area reaches a predetermined time in the still-image mode, the driving controller allows the display panel to be refreshed by the image data signal read from the memory.

14. The electronic device of claim 13, wherein when the current image corresponding to the second display area of the display panel is different from the previous image corresponding to the second display area of the display panel, the processor outputs the transmission signal corresponding to the second display area of the display panel, and
wherein the driving controller stores the image data signal corresponding to the second display area of the display panel in the memory.

15. The electronic device of claim 13, wherein during a refresh frame of the still-image mode, the driving controller reads out the image data signal corresponding to a full image of the display panel from the memory.

16. The electronic device of claim 15, wherein when the full image of a current frame is identical to the full image of a previous frame in the still-image mode, the processor does not output the transmission signal.

17. A driving circuit comprising:
a driving controller which receives a transmission signal from an outside and outputs an image data signal based on the transmission signal; and
a data driving circuit which converts the image data signal into a data signal,
wherein the driving controller includes a memory which stores the image data signal,
wherein when a display time of a still image reaches a predetermined time in a still-image mode, the driving controller outputs the image data signal read from the memory to the data driving circuit.

18. The driving circuit of claim 17, wherein during a refresh frame of the still-image mode, the driving controller reads out the image data signal corresponding to a full image of a display panel from the memory and outputs the image data signal corresponding the full image of the display panel to the data driving circuit.

19. The driving circuit of claim 17, wherein the driving controller further includes:
a receiver which restores an image signal, a multi-frequency mode signal, and a still-image mode signal based on the transmission signal, wherein the image signal, the multi-frequency mode signal, and the still-image mode signal are included in the transmission signal; and
a controller which converts the image signal into the image data signal, and
wherein when the display time of the still image reaches the predetermined time while the still-image mode signal is at an active level, the controller outputs the image data signal read from the memory.

20. The driving circuit of claim 19, wherein when the multi-frequency mode signal is at the active level and the still-image mode signal is at an inactive level, the memory is maintained in an off state.
